(19) United States
(12) Patent Application Publication
(10) Pub. No.: US 2007/0244639 A1
(43) Pub. Date: Oct. 18, 2007

(54) AUTOPILOT DISPLAY SYSTEM

(75) Inventors: Paul Butterworth, Auckland (NZ); Chris Richardson, Auckland (NZ); Peter Stevens, London (GB)

Correspondence Address: BANNER & WITCOFF, LTD., TEN SOUTH WACKER DRIVE, SUITE 3000, CHICAGO, IL, 60606, US

(73) Assignee: NAVMAN NEW ZEALAND, Auckland (NZ)

(21) Appl. No.: 11/675,282

(22) Filed: Feb. 15, 2007

Related U.S. Application Data
(60) Provisional application No. 60/743,307, filed on Feb. 16, 2006.

(51) Int. Cl. G01C 21/34

(52) U.S. Cl. 701/211

(57) ABSTRACT

Embodiments of the invention provide an autopilot display system and method that provides a simultaneous display of two possible positions or courses. The system can display the predicted position of a vessel if a first autopilot maneuver is selected and the predicted position of the vessel if a different autopilot maneuver no maneuver is selected. The user of the system then has a clear idea of the consequences of the selection of a particular maneuver. The system may also include means to select a maneuver directly from the display.

This application claims benefit to U.S. Provisional Application No. 60/743,307, entitled “Autopilot Display System” filed Feb. 16, 2006; the entire disclosure of which is hereby incorporated by reference.

### FIELD OF THE INVENTION

The present invention relates to a display for use with an autopilot, in particular for a marine autopilot for a boat.

### BACKGROUND TO THE INVENTION

Marine autopilots typically allow the operator to command the autopilot to carry out a fixed manoeuvre. The manoeuvre may be a “dodge” procedure, which causes the vessel to turn off course by a certain amount with the intention of dodging an obstacle, a turn through a fixed angle, or a tack or a gybe. In a dodge maneuver, the operator then usually has the option of resuming the original course or continuing on whatever course the vehicle has dodged to.

FIGS. 1 and 2 show examples of autopilot display screens in accordance with the prior art. These display screens simply show the word “dodge” on the screen to indicate that the auto pilot is performing a dodge action.

However, many boat users do not use their autopilot because they are unsure what the boat will do during a given maneuver. There is typically no indication of how the vessel will move during a dodge, how it will progress through the dodge maneuver or what will happen when the particular keys are pressed. Selection of the wrong option using an autopilot can steer into trouble rather than away from it, and panic then sets in when the user tries to abort the maneuver.

Accordingly, it is an object of the present invention to provide a more informative user interface for marine autopilots that allows a user to more clearly see what the consequences of various actions are, or at least to provide the public with a useful choice.

### SUMMARY OF THE INVENTION

According to a first aspect, the present invention a display system for an autopilot for a vehicle comprises a processor for calculating a first predicted position for the vehicle during a first autopilot maneuver and a second predicted position for the vehicle based on current settings or on a second autopilot maneuver; and a display for graphically representing the first and second predicted positions simultaneously.

The processor may be adapted to calculate a first predicted course for the vehicle during a first autopilot maneuver and a second predicted course for the vehicle based on current settings or on a second autopilot maneuver; and the display is adapted to graphically represent the first and second predicted courses simultaneously.

The display system may include a selection means which allows either the first or second predicted position or course to be selected by the user and an auto pilot controller connected to the selection means for steering the vehicle based on the predicted position or course selected. The selection means may be presented on the display proximate to the displayed position or course to which they relate.

The display may also include a representation of the vehicle. The display may be animated to show the changing position of the vehicle with time.

The first and second courses may be displayed as representations of a plan view of the courses. Alternatively, the first and second courses may be displayed as perspective representations of the courses.

The first and second positions or courses may be displayed simultaneously in a single viewing window. In one implementation, only a single representation of the vehicle is displayed.

According to a second aspect, the present invention comprises a method for providing autopilot information comprising the steps of: calculating a first predicted position for the vehicle during a first autopilot maneuver; calculating a second predicted position for the vehicle based on current settings or on a second autopilot maneuver; and graphically representing the first and second predicted positions simultaneously.

### BRIEF DESCRIPTION OF THE DRAWINGS

Examples of the present invention will now be described with reference to the accompanying drawings, in which;

FIG. 1 illustrates a typical auto pilot display in accordance with the prior art;

FIG. 2 illustrates another auto pilot display in accordance with the prior art;

FIG. 3 is a schematic diagram of an autopilot system in accordance with the present invention;

FIG. 4 shows the display module of the autopilot system shown in FIG. 3; and

FIGS. 5 to 10 show example display screens for an auto pilot system in accordance with the present invention.

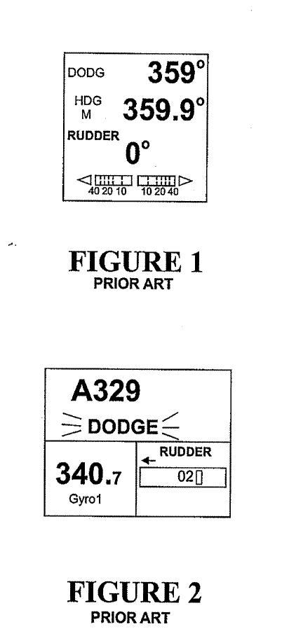

### DETAILED DESCRIPTION

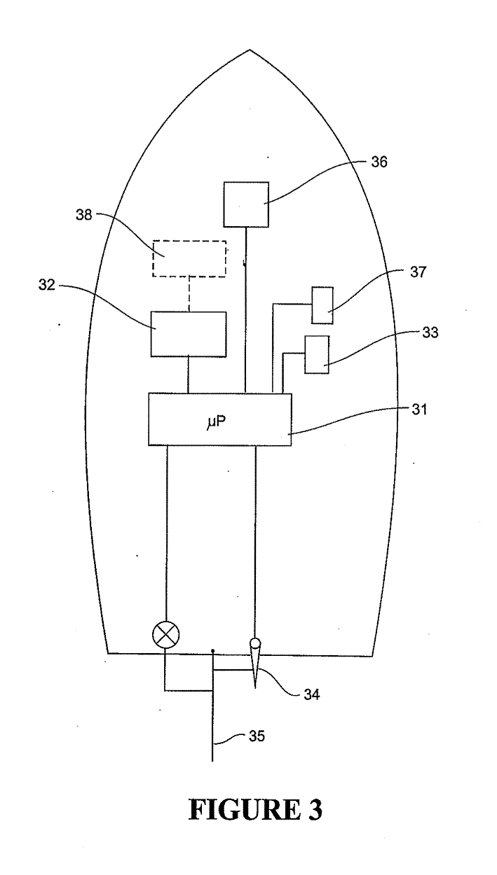

FIG. 3 is a schematic illustration of an autopilot system in accordance with the present invention. FIG. 3 shows a boat 30 on which the autopilot system is installed. The autopilot comprises a control unit 31, a display module 32, a heading sensor 33 and a rudder angle sensor 34 coupled to a rudder 35. Also shown are a GPS sensor 36 and a wind sensor 37. The control unit is connected to each of the sensors and to the display module 32 via wired or wireless connections. The control unit 31 is also connected to a motor that is used to alter the rudder angle. A further display unit 38 is shown, which can be connected to the display module 32, and hence indirectly to the control unit, in a daisy chain configuration.

The operation of the system shown in FIG. 3 will now be described.

The control unit 31 receives information about current boat settings, such as current heading and rudder angle, as well as other information such as absolute position and wind speed and direction, from the various connected sensors 33-37. Using this information the control unit is able to calculate a predicted future position(s) or a predicted course for the boat if the settings remain the same. The control unit sends the predicted course to the display module 32 for graphical display. The autopilot is also able to calculate the rudder settings required to carry out a number of fixed maneuvers and a predicted course if one of those maneuvers is performed. The predicted course during the maneuver is also sent to the display. The display can then show a graphical representation of the predicted course based on current settings and the predicted course during the autopilot maneuver simultaneously.

This makes it clear to the user what the boat will do during the maneuver as compared to the current course.

In one embodiment of the present invention, it is also possible to display the predicted courses for two or more autopilot maneuvers simultaneously, with or without a predicted course based on current settings.

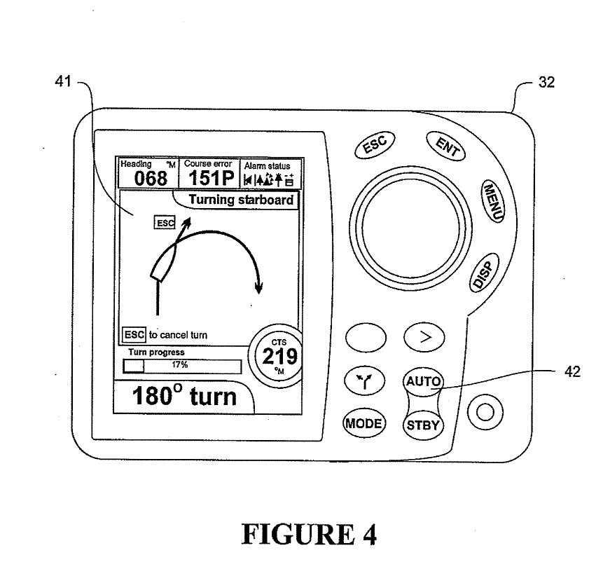

FIG. 4 shows the display module 32 in more detail. The display module 32 comprises a display screen 41 and a plurality of user interface buttons 42. The user interface buttons allow different display modes to be selected as well as headings to be set and autopilot maneuvers to be selected. The available autopilot maneuvers include tack/gybe, 90° turn to port or starboard, 180° turn to port or starboard and dodge to port or starboard. For the dodge maneuver there are also options to return to the original course or to return to the original heading. Returning to the original course is available if an absolute positioning system, such as GPS, is connected to the autopilot system.

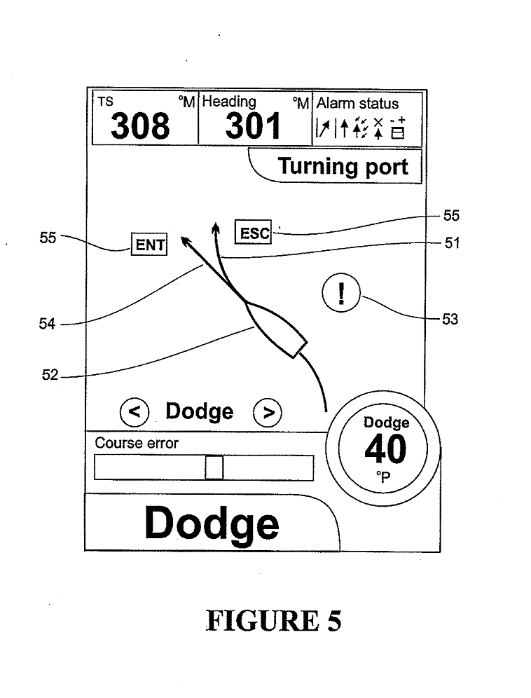

The autopilot system of the present invention provides dedicated graphical displays when an autopilot maneuver is selected and performed. When the user selects a maneuver, the display module 32 communicates the selection to the control unit 31. The control unit calculates a predicted course for the boat and sends the predicted course information to the display unit for display. In the example shown in FIG. 5, the predicted course based on current settings is displayed graphically. FIG. 5 shows the display when a dodge maneuver is selected in a compass mode (i.e. based on heading not absolute position). The predicted course is indicated by an arrow 51 representing a plan view of the predicted path of the boat. The boat itself is shown as an icon 52 and the obstacle being avoided is represented by an exclamation mark 53.

As can be seen from FIG. 5, the boat is expected to return to the same heading after the doge maneuver has been completed. The predicted course of the boat based on current settings (i.e. if the dodge maneuver is aborted before completion) is shown as arrow 54. However, arrow 54 could equally represent an alternative autopilot maneuver available to the user. Adjacent to arrows 51 and 54 are boxes 55, 56 marked “ESC” and “ENT”. ESC and ENT are keys on the autopilot display module 32. The box 55 marked ESC indicates that if the user presses ESC, the dodge maneuver will be performed by the autopilot. The box 56 marked ENT indicates that if the ENT button is pressed by the user, the boat will continue on its current course as soon as the button is pressed. The dodge maneuver can be made to execute a sharper turn by repeated pressing of the appropriate button on the display console 32. The display shown in FIG. 5 shows the dodge maneuver turning through 40 degrees but the dodge can be made sharper in increments of 20 degrees in this example, although any increment may be used, or a sliding scale. The display in FIG. 5 includes various other information, including the direction of the turn maneuver (in this case to port) the angle through which the boat will turn and the heading of the boat. It is also very clearly indicated that it is a dodge maneuver that is being performed.

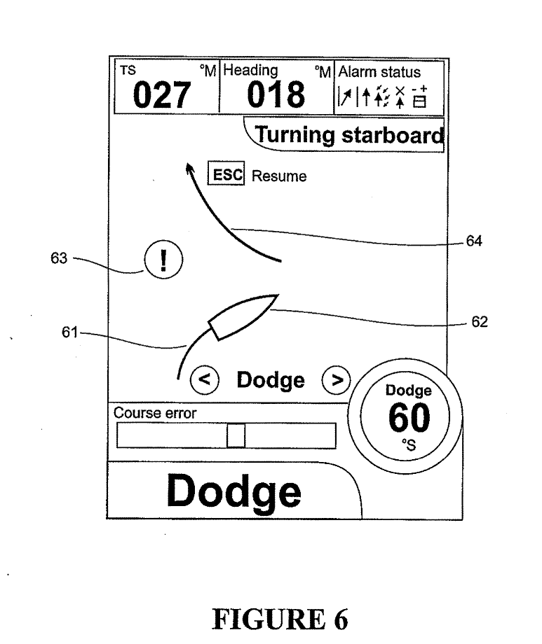

FIG. 6 shows a dodge maneuver screen when the autopilot is in a GPS mode, and therefore able to calculate an absolute position. In this mode, after the dodge maneuver is completed the boat will return to its original course. This is compared to the compass mode described above with reference to FIG. 5 in which the boat returns to its original heading. The display shown in FIG. 6 shares most of its features with that shown in FIG. 5. In FIG. 6, the dodge maneuver is a turn through 60 degrees. The obstacle being dodged is again represented by an exclamation mark 63. The predicted course of the boat is shown by line 61, the boat is shown in outline as icon 62. In a GPS mode, the predicted path of the boat is shown for when/if the user chooses to resume their original course as arrow 64. A box marked “ESC” with the word “resume” is shown next to arrow 64 to make it clear to the user that pressing the ESC button will make the boat resume its original course, following the path shown by arrow 64.

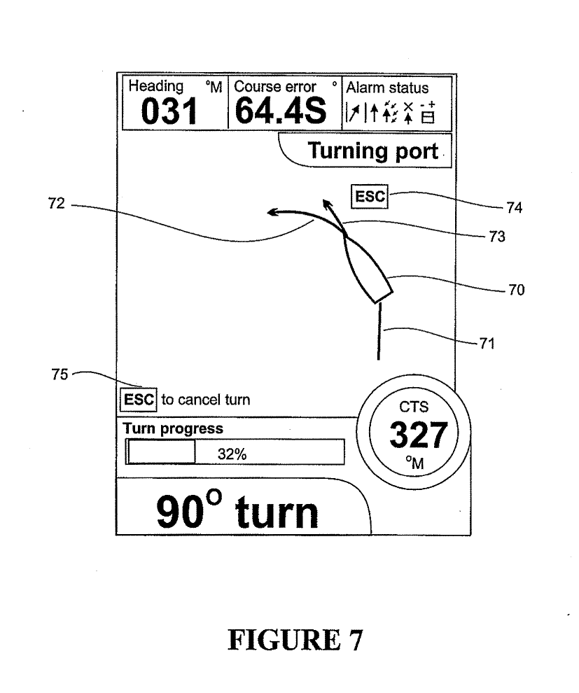

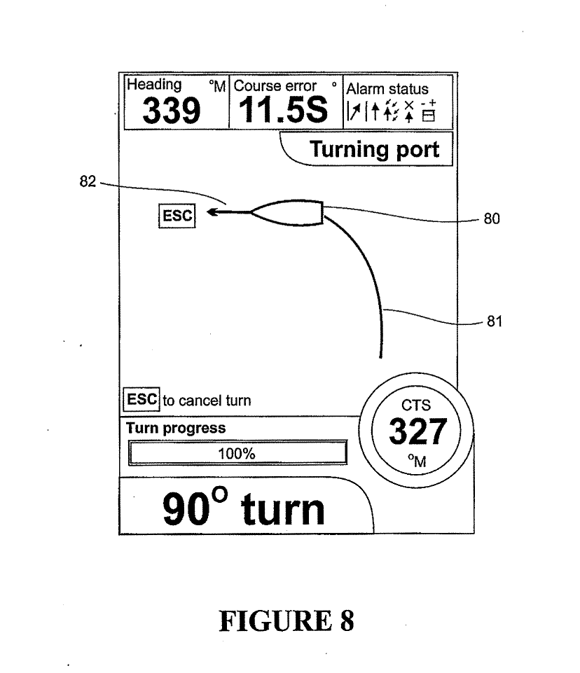

FIG. 7 and 8 show a 900 turn to port display screen in accordance with an embodiment of the present invention. In FIG. 7, the turn is shown at 32% completion. The boat is shown by icon 70. The course of the boat through the maneuver is shown by arrows 71, 72. The section already completed is shown by line 71, the predicted future course is shown by arrow 72. The predicted course of the boat if the maneuver is cancelled and continues on its current heading is shown by arrow 73. Box 74 next to arrow 73 indicates that ESC must be pressed to follow the course shown by arrow 73. This is further reinforced by ESC box 75 which is presented in the bottom left corner of the screen, accompanied by the words “to cancel turn”.

The display is animated throughout the maneuver. The position of the boat and of arrow 73 changes with time. FIG. 8 shows the display for the turn of FIG. 7 at completion of the maneuver, an instant before the display returns to a normal autopilot user interface. The boat 80 is turned through 900 from its original course 81. The arrow 82 indicating the course if the maneuver is aborted is in the same direction as the completed turn. The turn progress is indicated as 100%, in other words complete.

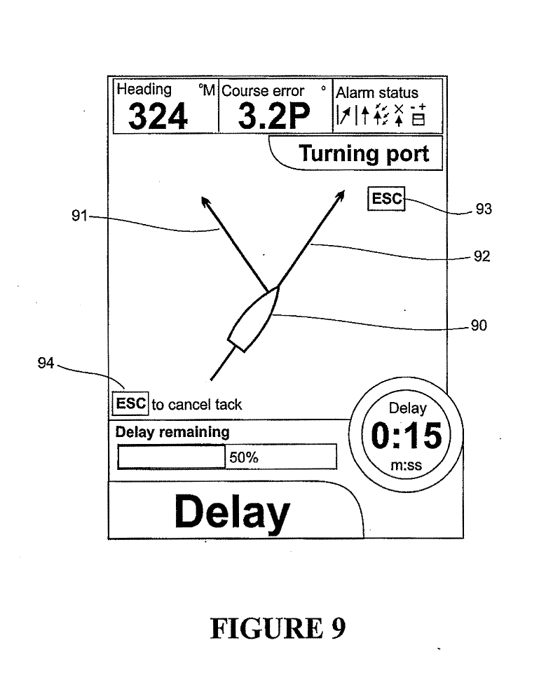

FIG. 9 shows a display screen for an autopilot system in accordance with the present invention. The screen shows a tack maneuver when the autopilot system is in a wind mode, i.e. when the heading of the boat is calculated relative to the direction of the measured wind. Arrow 91 shows the predicted coarse of the boat (shown by icon 90), following the tack maneuver. Arrow 92 shows the predicted course of the boat based on current settings. Boxes 93 and 94 show the user that pressing the ESC button will cancel the tack maneuver, whereupon the boat will follow the course indicated by arrow 92. Also shown is a time or delay remaining until the tack is performed, in this case 15 seconds. (In this example, there is a delay of 30 seconds from the time at which the tack maneuver is selected to execution of the tact. However, any appropriate delay time, including no delay at all, may be used.)

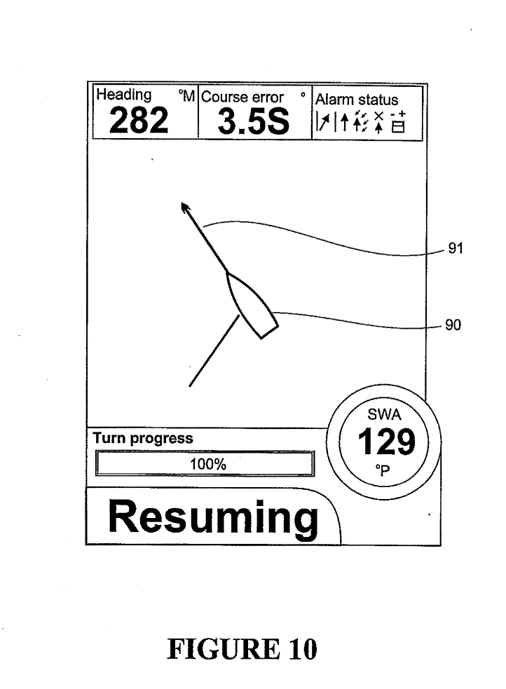

FIG. 10 shows the display for the tack maneuver of FIG. 9, 15 seconds later i.e. at the point of the turn. FIG. 10 shows the boat 90° turn to its new course on arrow 91. There is no longer the option to cancel the tack as it has already been performed. The display screen indicates that the turn has progressed 100%, in other words is complete, and that the normal operation is resuming. The display screen returns to a basic autopilot display screen shortly after the maneuver is completed.

Embodiments of the present invention provide clear and unambiguous display to the user of an autopilot system, which allows the user to see what the consequences of various actions are. It allows users to operate their autopilot system with confidence and without panic, so that they can get the full benefit of the autopilot.

1. A display system for an autopilot for a vehicle comprising:
a processor for calculating a first predicted position for the vehicle during a first autopilot maneuver and a second predicted position for the vehicle based on current settings or on a second autopilot maneuver; and
a display for graphically representing the first and second predicted positions simultaneously.

2. A display system according to claim 1, wherein the processor is adapted to calculate a first predicted course for the vehicle during a first autopilot maneuver and a second predicted course for the vehicle based on current settings or on a second autopilot maneuver; and
wherein the display is adapted to graphically represent the first and second predicted courses simultaneously.

3. A display system according to claim 1, further comprising:
a selection means that allows either the first or second predicted position or course to be selected by the user; and
an auto pilot controller connected to the selection means for steering the vehicle based on the predicted position or course selected.

4. A display system according to claim 3, wherein the selection means are presented on the display proximate to the displayed position or course to which they relate.

5. A display system according to claim 1, wherein the display is adapted to display a representation of the vehicle.

6. A display system according to claim 5, wherein only a single representation of the vehicle is displayed.

7. A display system according to claim 1, wherein the display is animated to show the changing position of the vehicle with time.

8. A display system according to claim 2, wherein the first and second courses are displayed as representations of a plan view of the courses.

9. A display system according to claim 2, wherein the first and second courses are displayed as perspective representations of the courses.

10. A display system according to claim 1, wherein the first and second positions or courses are displayed simultaneously in a single viewing window.

11. A method for providing autopilot information comprising the steps of:
calculating a first predicted position for the vehicle during a first autopilot maneuver;
calculating a second predicted position for the vehicle based on current settings or on a second autopilot maneuver; and
graphically representing the first and second predicted positions simultaneously.

12. A method according to claim 11, further comprising the steps of:
calculating a first predicted course for the vehicle during a first autopilot maneuver;
calculating a second predicted course for the vehicle based on current settings or on a second autopilot maneuver; and
graphically representing the first and second predicted courses simultaneously.

13. A method according to claim 11, further comprising the step of providing selection means on the display proximate to the displayed position or course to which they relate to allow a user to select a position or course to steer to.

14. A method according to claim 11, further comprising the step of displaying a representation of the vehicle.

15. A method according to claim 14, wherein the step of displaying a representation of the vehicle comprising displaying only a single representation of the vehicle.

16. A method according to claim 11, further comprising the step of displaying the changing position of the vehicle with time in an animated display.

17. A method according to claim 12, wherein the first and second courses are displayed as representations of a plan view of the courses.

18. A method according to claim 12, wherein the first and second courses are displayed as perspective representations of the courses.

19. A method according to claim 11, wherein the step of graphically representing the first and second positions or courses comprises representing the first and second positions or courses simultaneously in a single viewing window.
